(19) United States
(12) Patent Application Publication
(10) Pub. No.: US 2025/0178685 A1
(43) Pub. Date: Jun. 5, 2025

(54) SCOOTER-LIKE VEHICLE WITH OPTIMIZED LOADING SPACE

(71) Applicant: CONSTIN GMBH, Berlin (DE)

(72) Inventor: Hans-Peter CONSTIEN, Berlin (DE)

(73) Assignee: CONSTIN GMBH, Berlin (DE)

(21) Appl. No.: 18/844,179

(22) PCT Filed: Mar. 2, 2023
(86) PCT No.: PCT/DE2023/100168

§ 371 Date: Sep. 5, 2024

(30) Foreign Application Priority Data
Mar. 11, 2022 (DE) 10 2022 000 846.7

(51) Int. Cl. B62J 9/14; B62J 9/16; B62J 43/28

(52) U.S. Cl. CPC B62J 9/14; B62J 9/16; B62J 43/28

(57) ABSTRACT

A vehicle based upon a vehicle concept relating to a scooter-like vehicle with or without a track width, having a vehicle longitudinal axis, a vehicle frame, a footwell, and a storage space under a seating device, is characterized in that the footwell comprises a usable area which extends under the seating device and delimits a storage space on the floor under the seating device, wherein the footwell is connected to the storage space via an opening, which has a predetermined opening profile.

The present invention relates to a vehicle based upon a vehicle concept relating to a scooter-like vehicle comprising a motor drive device, with or without a track width, having a vehicle longitudinal axis, a chassis, a footwell, and a storage space under a seating device.

Such vehicles are equipped with combustion engines or electric drives. Such vehicles, which are usually single-track vehicles, are suitable only to a limited extent for the transport of goods. For this purpose, panniers are used, which are attached in the middle at the rear or on the left and right at the rear, as well as tank bags on motorcycles. Goods are also transported between the legs in the footwell of scooters.

There is also storage space for goods under the seat or bench seat. The storage space there is accessible by folding up the bench seat. The bench seat compartment is often used to store the helmet. The bench seat compartment is usually lockable, so that valuables can also be safely stored there. In electric scooters, batteries are often stored in the bench seat compartment, which has the disadvantage that there is no longer any space available for the helmet. In scooters where the battery is stored in the footwell, the bench seat compartment remains free. However, the volume is also often limited, in the case of such solutions, by the fact that part of the engine electronics, often the engine controller, is installed there.

Electric scooters and similar vehicles are becoming increasingly popular because they weigh very little compared to cars and therefore consume little energy. Such vehicles make sense in terms of sustainability and the shift in modes of transport. A major disadvantage is that only a small load can be transported safely and that certain designs do not have a lockable bench seat compartment.

Such a vehicle of the known prior art is known, for example, from JP 2552203B2, JP 3160932B2, and WO 2009/132768A1. The two-wheelers known from this prior art have a lockable bench seat under which one or two helmets can be stored. For this purpose, a storage space is formed under the actual seat, which is accessible from above when the bench seat is folded up. Goods of larger dimensions than helmets, which are essentially adapted to the storage space, cannot be stored in such a storage space. For example, it is not possible to store a beverage crate in these known storage spaces.

The object of the present invention is therefore to further develop a vehicle of the type mentioned at the outset in such a way that, in addition to the transport of persons in the permitted number of persons, it is also possible to safely transport larger goods than in the prior art.

The object is achieved according to the invention in that the footwell comprises a usable area which extends under the seating device and delimits a storage space on the floor side under the seating device, wherein the footwell is connected to the storage space via an opening which has a predetermined opening profile.

An advantage of the present invention is that the opening between the footwell and the storage space significantly increases the usable area and is not limited only to at least part of the footwell. This means that longer objects can be transported essentially parallel to the longitudinal axis, or several larger objects can be transported one behind the other in the longitudinal direction. The predetermined opening profile is particularly favorable in this case. The opening width can thus be adapted to a certain extent to the volume of goods to be transported.

A further advantage of the present invention is that the opening can be at least partially closed with a surface element. This means that goods can also be received and locked only in the storage space, so that they are kept safe there.

The opening can also be only partially closed, so that its profile can thus be adjusted to the goods or the shape of the goods being loaded from the footwell to the storage area. This will then more or less fix the goods in their position.

For this reason, it is also advantageous if the surface element is attached to the chassis or the seating device so that it can be moved in both directions between an open position and a closed position. The displaceability of the surface element means that the opening profile can also be changed in a stepless manner.

It is also an advantage of the present invention that the opening profile of the opening has a height of 200 mm to 500 mm, a width of 200 mm to 500 mm, and/or the usable area in the direction of the longitudinal axis has a length of 600 mm to 1,000 mm. These dimensions are essentially twice the standardized sizes of the most common beverage crates. With these dimensions, the vehicle according to the present invention can load two beverage crates one behind the other in the longitudinal direction, wherein a first crate then stands on the usable area in the footwell, and a second crate stands on the usable area in the storage space.

Further advantages of the present invention emerge from the further features of the further claims.

An embodiment of the present invention is described in more detail below with reference to the drawings, in which:

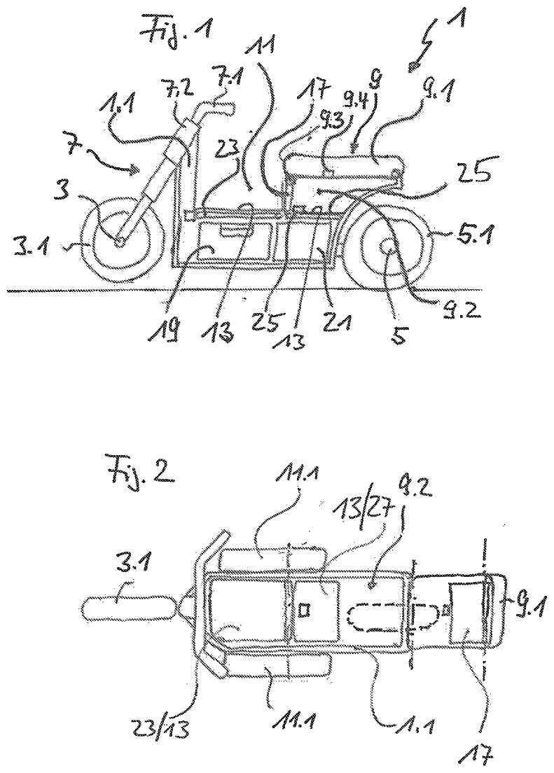

FIG. 1 is a schematic side view of a vehicle according to the present invention according to a first embodiment, having a surface element in the closed position, which closes an opening under a closed seating device;

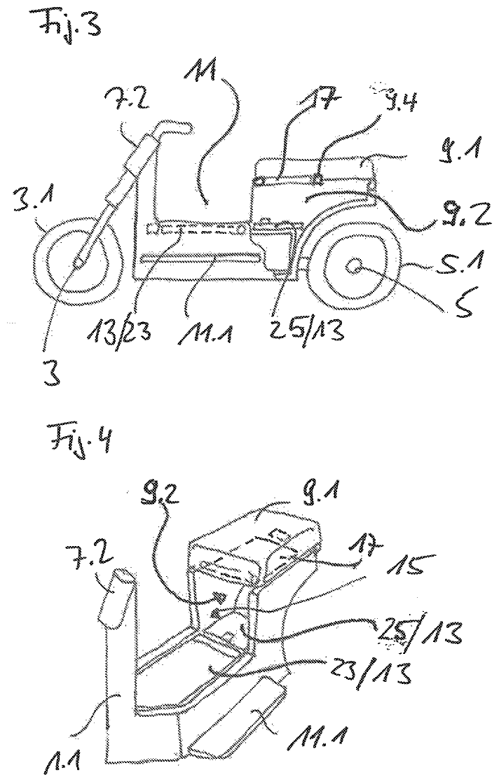

FIG. 2 is a schematic plan view of the vehicle from FIG. 1;

FIG. 3 is a schematic side view of the vehicle from FIG. 1, having the surface element in the open position;

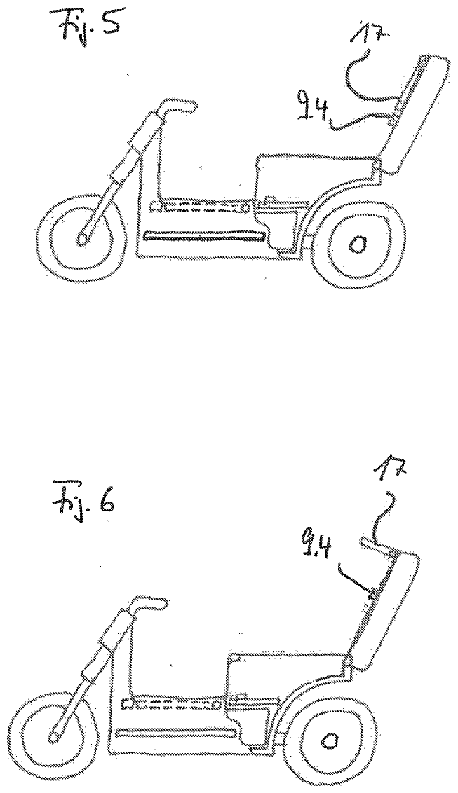

FIG. 4 is a schematic perspectival partial view of the vehicle from FIG. 1 having the surface element in the open position;

FIG. 5 is a schematic side view of the vehicle from FIG. 1 in a variant in which the surface element is hinged to a bench seat and folded in, and the bench seat is in the open position;

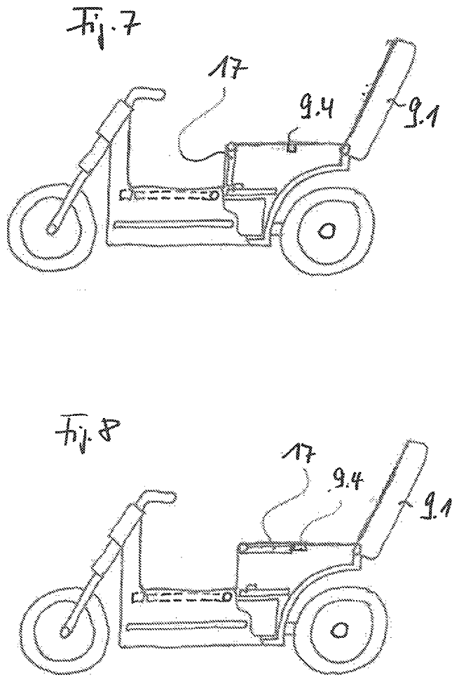

FIG. 6 is a schematic side view of the vehicle from FIG. 5 having the surface element in a folded-out position and the seating device in the open position;

FIG. 7 is a schematic side view of the vehicle from FIG. 5 or 6 in a variant in which the surface element is hinged to the seating device independently of the bench seat and is in the closed position;

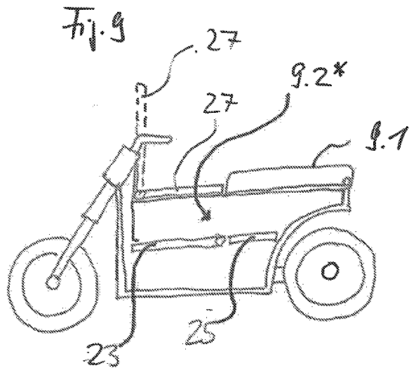

FIG. 8 is a schematic side view of the vehicle from FIG. 7, wherein the surface element is in the open position;

FIG. 9 is a schematic side view of the vehicle from FIG. 1 in a second embodiment having a storage space extended towards the front.

FIG. 1 is a schematic view of a vehicle 1 based upon a vehicle concept relating to a scooter-like vehicle. In the context of the present invention, the terms “scooter-like vehicle” and “vehicle concept” mean that vehicle concepts developed for single-track two-wheelers, e.g., motor scooters, are also applicable to three-wheeled vehicles—for example, trikes. These have, for example, two tracks at the front or (usually) at the rear. Such vehicle concepts also include certain four-wheeled vehicles, such as quads.

In FIG. 1 and FIG. 3, a motor scooter having an electric drive is shown as the vehicle 1 by way of example. For the present invention, the drive or the type of drive is not important. The invention is aimed at optimizing the space available for the safe transport of goods, regardless of the drive or type of drive.

The vehicle 1 comprises a vehicle frame 1.1 and a front axle 3 having a front wheel 3.1 and a rear axle 5 having a rear wheel 5.1. A steering device 7 having a handlebar 7.1 and a steering head 7.2 is connected to the front axle 3. The vehicle frame 1.1 extends spatially between the front axle 3 and the rear axle 5. Numerous concepts are known for the construction of the vehicle frame 1.1 and the connection of the same to the front axle 3, e.g., via the steering device 7, and the connection to the rear axle 5, which a person skilled in the art can also implement with this invention. These are therefore not part of the present invention.

The vehicle 1 has a longitudinal vehicle axis and comprises a seating device 9, which in the embodiment shown in FIG. 1 has a bench seat 9.1 in the direction of the longitudinal vehicle axis, such that two people can sit one behind the other. In other embodiments, the seating device 9 may also comprise one or more individual seats.

Between the seating device 9 and the steering device 7, the vehicle frame 1.1 forms a footwell 11. In the context of the present invention, the term “footwell” means a space in which a person's feet and legs can and should move—for example, when getting onto or into the vehicle 1. The feet can, but do not have to, be placed in the footwell 11.

FIG. 2 is a schematic plan view of the vehicle 1. In addition to the footwell 11, a running board 11.1 is provided on both sides of the vehicle longitudinal axis, on which the left and right foot, respectively, of one or more persons can be placed.

In FIG. 4, a part of the vehicle 1 is shown schematically. The footwell 11 has a usable area 13, which in the illustrated embodiment is planar or flat. In other embodiments, however, the usable area 13 can also have a surface structure or surface profile, which can, for example, comprise a step or the like transverse to the vehicle longitudinal axis.

In the embodiment shown in FIG. 1, FIG. 2, FIG. 3, and FIG. 4, a storage space 9.2 is formed below the seating device 9. The storage space 9.2 is de-limited at the top by the bench seat 9.1. In the embodiment shown, the bench seat 9.1 is pivotably mounted on the vehicle frame 1.1 or the seating device 9. In other embodiments, the bench seat 9.1 can also be rigidly connected to the seating device 9 or the vehicle frame 1.1.

In FIG. 5, the bench seat 9.1 is shown in an open position, in which it has been pivoted upwards to the rear about a pivot axis running transversely to the vehicle longitudinal axis. In other embodiments, the bench seat 9.1 can also be pivoted about an axis parallel to the vehicle longitudinal axis. In still other embodiments, the bench seat 9.1 can also be movable or, alternatively or in addition to being pivotable or movable, can also be completely removable.

FIG. 4 also shows that the storage space 9.2 under the bench seat 9.1 is accessible from the footwell 11. For this purpose, the seating device 9 has an opening 15 below the bench seat 9.1. In the present embodiment, the usable area 13 of the footwell 11 extends through the opening 15 into the storage space 9.2. In the embodiment shown, as already mentioned, the usable area is completely flat or planar. In other embodiments, the usable area 13 can have a shoulder, threshold, or edge in the region of the opening 15, i.e., at the transition from the footwell 11 and the storage space 9.2, such that the usable area 13 in the storage space is higher or lower in relation to a horizontal position of the vehicle 1. In other embodiments, the usable area 13 can also have a slope in the direction of the rear wheel axle 5. The slope may already begin in the footwell 11, or only in the region of the opening 15.

The opening 15 is closable. For this purpose, a surface element 17 is movably arranged on the seating device 9 or on the vehicle frame 1.1, such that this surface element 17 can be moved back and forth between a closed position and an open position. In FIG. 1, the surface element 17 is in its closed position. In FIG. 3 and FIG. 4, the surface element 17 is in each case in its open position.

In the embodiment shown in the figures, the surface element 17 is attached to a front end 9.3 of the bench seat 9.1 and can be pivoted about an axis transverse to the vehicle longitudinal axis. FIG. 5 shows the way in which the surface element 17 is pivoted inwards and under the bench seat 9.1, into its open position, and is also held in this open position by a bench seat latch 9.4. In other embodiments, the surface element 17 can also be designed as a laterally hinged flap or as a type of roller door.

In the opened state, the surface element 17 is stowed in the storage space 9.2 under the bench seat, as shown in FIG. 3. In this state, goods can be placed and transported on the usable area 13 extending from the footwell 11 into the storage space 9.2.

In the embodiment shown, the opening 15 has the largest possible opening profile, so that goods can be stowed from the front, or, when the bench seat 9.1 is open, also from above, which can take up the entire length between a front geometry of the vehicle frame 1.1, connecting the steering head 7.2 of the vehicle 1, and a cover of the rear wheel.

In the present embodiment, the opening profile of the opening 15 has a width and/or a height in a range of 200 mm to 500 mm. These dimensions include all common widths and/or heights of standardized bottle crates. In other embodiments, the opening profile can be adapted in its width and/or height to the width and/or height of a bottle crate in the aforementioned size range. In the embodiment shown, the usable area 13 has a length in the range of 600 mm to 1,000 mm in the direction of the vehicle longitudinal axis. A length in this value range essentially corresponds to a length of two bottle crates having a width and/or height from the above-mentioned value range of 200 mm to 500 mm, so that two beverage crates can be positioned one behind the other in the direction of the vehicle longitudinal axis on the usable area 13, wherein one is at least partially positioned in the storage space 9.2 and the other in the footwell 11.1. A person's feet can then be placed next to the beverage crates on one of the running boards 11.1.

In the embodiment shown, the storage space 9.2 is closed at the side by a trim of the seating device 9. The spatial profile corresponds in height and width to the opening profile. If the opening profile can be changed to adapt to the size of the outline of a beverage crate, the spatial profile can also enclose a larger width than the opening profile. It is also conceivable that the spatial profile can be adapted to the size of a beverage crate.

In order for the storage space 9.2 to have as large a volume as possible, a battery 19 and vehicle electronics 21 are moved as far downwards as possible, taking into account sufficient ground clearance, and are located below the usable area 13 in the embodiment shown in FIG. 1. Above the battery 19 and vehicle electronics 21, the usable area 13 extends as a continuous plane. In the usable area 13 in the footwell 11, a battery cover 23 is formed for access to the battery 19. Below the storage space 9.2, an electronics cover 25 is formed in the usable area 13. The storage space 9.2, which is accessible by folding up the bench seat 9.1, is accessible for maintenance purposes after removing the electronics cover 25 and the vehicle electronics 21.

The battery 19 and the vehicle electronics 21 can be mounted on a common, pre-mounted electronics board. The surface element 17 can be locked by a first locking device 25 within the storage space 9.2, so that, when the bench seat 9.1 is closed (bench seat 9.1 in the closed position), the surface element 17 cannot be opened from the outside. The battery cover 23 is locked by a second locking device 26, which is accessible after opening the bench seat 9.1 (bench seat 9.1 in the open position).

In order that the opened surface element 17 not hinder the insertion of the goods from above, it is preferably attached below, above the electronics cover 25 (FIG. 3), laterally within the side walls of the storage space 9.2 bench seat compartment, or foldably on the bench seat 9.1. The surface element 17 can also be designed as a removable, loose part. In the embodiments in which the surface element 17 is attached to the bench seat 9.1 so as to also be movable (FIGS. 5 and 6), the surface element 17 is held by the bench seat latch 9.4 on the bench seat 9.1 when the latter is in a position in which the storage space 9.2 is open.

In FIG. 9, a second embodiment of the overall structure of the vehicle 1 is shown schematically. In this second embodiment, in order to attain a larger lockable storage space 9.2, the storage space 9.2* is extended forwards into the footwell 11 and overlaps a region of the battery cover 23. This extension can extend as far as the front part of the vehicle frame 1.1. A front region 9.5*, which is located in front of the bench seat 9.1 in the direction of travel, has a separate access cover 27.

After opening the large access cover 27 and the bench seat 9.1, a very large storage space 9.2* is accessible.

The extension of the lockable storage space according to the second embodiment has the disadvantage that no bulky objects can be transported transversely above the battery cover 23 in the footwell 11 of the vehicle 1. The extension of the storage space 9.2 to the very large storage space 9*, forwards into the footwell 11, can also be designed as a detachable separate element that can be removed if necessary.

### LIST OF REFERENCE SIGNS

1 Vehicle
3 Front axle
3.1 Front wheel
5 Rear axle
5.1 Rear wheel
7 Steering device
7.1 Handlebar
7.2 Steering head
9 Seating device
9.1 Bench seat
9.2 Storage space
9.2* Extended storage space
9.3 Front end of the bench seat 9.1
9.4 Bench seat latch
9.5* Front region
11 Footwell
11.1 Running board
13 Usable area
15 Opening
17 Surface element
19 Battery
21 Vehicle electronics
23 Battery cover
25 Electronics cover
26 Locking device
27 Access cover

1. A vehicle based upon a vehicle concept relating to a scooter-like vehicle with or without track width, having a vehicle longitudinal axis, a vehicle frame, a footwell, and a storage space under a seating device,
characterized in that
the footwell comprises a usable area which extends under the seating device and delimits a storage space on the floor side under the seating device, wherein the footwell is connected to the storage space via an opening which has a predetermined opening profile.

2. The vehicle according to claim 1,
characterized in that
the opening can be closed by a surface element.

3. The vehicle according to claim 2,
characterized in that
the surface element is attached to the vehicle frame or to the seating device so as to be displaceable or pivotable in both directions between an open position and a closed position.

4. The vehicle according to claim 1,
characterized in that
the opening profile of the opening has a height in a range of 200 mm to 500 mm.

5. The vehicle according to claim 1,
characterized in that
the opening profile of the opening(s) has a width in a range of 200 mm to 500 mm.

6. The vehicle according to claim 1,
characterized in that
the usable area in the direction of the vehicle longitudinal axis has a length in a range of 600 mm to 1,000 mm.

7. The vehicle according to claim 1,
characterized in that
the storage space has a spatial profile that corresponds to the opening profile.

8. The vehicle according to claim 2,
characterized in that
the surface element 4 is an element selected from the group of sliding doors, swing doors, rolling doors, or flaps.

9. The vehicle according to claim 1,
characterized in that
the usable area extends in a single horizontal plane, such that loading can be carried out from the footwell through the opening into the storage space in one plane.

10. The vehicle according to claim 1,
characterized in that
the usable area comprises at least one running board for feet.

11. The vehicle according to claim 10,
characterized in that
the usable area comprises at least two running boards for feet, which are arranged on both sides of the vehicle longitudinal axis.

12. The vehicle according to claim 1,
characterized in that
the seating device comprises two seats arranged one behind the other in the direction of the vehicle longitudinal axis.

13. The vehicle according to claim 1,
characterized in that
a functional space for accommodating a battery and vehicle electronics is formed below the usable area.
